(19) United States
(12) Patent Application Publication
(10) Pub. No.: US 2006/0062206 A1
(43) Pub. Date: Mar. 23, 2006

(54) Multi-link PPP over heterogeneous single path access networks

(76) Inventor: Vijayaraghavan Krishnaswamy, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/063,368

(22) Filed: Feb. 22, 2005

Related U.S. Application Data
(60) Provisional application No. 60/522,383, filed on Sep. 23, 2004.

(51) Int. Cl. H04L 12/66; H04L 12/413

(52) U.S. Cl. 370/352; 370/328; 370/465; 370/401

(57) ABSTRACT

Methods and apparatuses enabling secure multi-link point to point protocol over connected heterogeneous single path access networks are described. In one embodiment, a method of an access device includes associating the access device with a single-path network and at least one other network, and accessing a data of a service provider through an aggregation server connected to the single-path network and the other network. In one embodiment, the aggregation server transfers the data to the access device at a combined throughput speed of the single-path network and the at least one other network. The method may include maintaining a connection between the access device and the aggregation server even when any one or more of the single-path network and the at least one other network disconnect.

### RELATED APPLICATIONS

The present patent application claims priority from U.S. provisional patent application No. 60/522,383, filed on Sep. 23, 2004, entitled EFFICIENT USE OF HETEROGENEOUS ACCESS NETWORKS.

### BACKGROUND

1. Field of the Disclosure

The present embodiments relate to the field of data communications and more specifically to secure multi-link point to point protocol over connected heterogeneous single path access networks.

2. Discussion of Related Art

The most popular method for transporting internet protocol (IP) packets over a serial link between a user and a service provider is a point to point protocol (PPP). The point to point to point protocol (PPP) can run on any full-duplex link network, including a code division multiple access (CDMA) network, an integrated services digital network (ISDN), an Ethernet network (e.g., including wireless LAN Ethernet networks), a digital subscriber line network (e.g. a DSL/Cable network), and other wireless access (like GPRS/CDMA/WiMAX) network.

The multi-link point to point protocol (e.g., referred to as MLPPP, MPPP, and/or MLP, etc; hereinafter referred here as MLPPP) is an extension of the point to point protocol (PPP). MLPPP is used typically on homogeneous multiple path networks such as CDMA and ISDN etc. For example, MLPPP can be used in a basic rate homogeneous ISDN network (e.g., consisting of two 64 Kbps B-channels to carry data) to allow the B-channels (e.g., the B-channels are the main data channels in an ISDN) to be used in combination as a single transmission line to double the basic rate homogeneous ISDN network throughput to 128 Kbps.

Typically over a MLPPP connection, IP connectivity between the two sides are established. Secure communication is typically achieved by using IPSec protocol over the IP-connection, and thus encrypted data passes across both the B-channels.

A single-path access network is defined as a service-connection between the two sides, where typically only one point-to-point protocol (PPP) session is established for all data-transfer purposes. In such situations, use of MLPPP for such single-path access network has not been practical. Currently, a user does not have a mechanism to aggregate the bandwidth of heterogeneous networks (e.g., over different ones of ISDN, CDMA, Ethernet, and/or DSL/Cable networks). Furthermore, whenever multiple paths are aggregated, (e.g., the B-channels of an ISDN network and/or multiple paths within a CDMA network), encryption/decryption of data is limited to uniform application of rules to all pathways.

### SUMMARY

Methods and apparatuses of multi-link PPP over connected heterogeneous single path access networks are disclosed. In one aspect, a method of an access device includes associating the access device with a single-path network and at least one other single-path access network; and accessing the network of a service provider through an aggregation server connected to the single-path network and the other network, and enable data transfer between the access device and the aggregation server at a combined throughput speed of the single-path network and the at least one other network.

In another aspect, the method may further include maintaining a connection between the access device and the aggregation server even when any one or more of the single-path network and the at least one other network disconnect. In another aspect, the single-path network connecting the access-device and the aggregation-server may not be directly connected at layer-2 level, and so the access-device/aggregation-server may transmit at least some of the data through a layer 2 tunnel enabled through a proxy device within the single-path network. In another aspect, the proxy device may also be co-located within the access device. In one aspect, the method may encrypt the data across the multiple heterogeneous single-path networks, individually or selectively as needed. The encryption of the data may be performed only during a given time interval, based on configuration policies in the access-device and aggregation-server.

The single-path network may be one of an Ethernet network, a digital subscriber line network (e.g. a DSL/Cable network), and a general packet radio service/wireless access (GPRS/CDMA/WiMAX) network. The aggregation server may be a single point of connectivity between the single-path network and the at least one other network and a back-bone network. The service provider may be accessed through the back-bone network.

The association of the access device with a single-path network and the at least one other network may be formed through point to point (PPP) negotiations between the access device and the aggregation-server. The aggregation server may form a multi-link point-to-point (MLPPP) connection over the PPP-sessions formed over the single-path network and the at least one other network to form the combined throughput speed. In another aspect, the method may continue to use the MLPPP connection even when any one or more of the single-path network or the at least one other network restarts.

In a further aspect, a system includes a back-bone network, an aggregation server connected to the back-bone network to enable a multi-link point to point connection over heterogeneous single path access networks, a first single path network having a first access method and a second single path network having another access method connected to the aggregation server, and an access device associated with the first single path network and the second single path network.

In one aspect, a connection between the access device and the aggregation server may be maintained even when any one of the first single path network and the second signal path network is no longer associated with the access device. The system may also include a proxy device in the single path network to transmit/receive at least some of the data through a layer 2 tunnel when the single path network does not provide a direct layer-2 connectivity Furthermore the access device, the aggregation server, and the proxy device may encrypt/decrypt the data transmitted either of the first single path network or the second single path network based upon time dependant rules to form the secure multi-link point to point connection. The secure multi-link point to point connection may aggregate throughput of the first single path network and the second single path network. The first single path network having the first access method may be an Ethernet network and the second single path network having another access method may be a wireless local area network.

In yet a further aspect, a machine-accessible medium provides instructions that, if executed by a processor, will cause the processor to perform operations of an aggregation server, including receiving a data through a back-bone network from a service provider, aggregating bandwidth of a first single path network and a second single path network, both of which are connected to an access device, encrypting/decrypting some of the data based upon time sensitive-policies and transmitting/receiving the data to/from the access device over the available single path networks at the aggregated bandwidth speeds.

The machine-accessible medium may include instructions for tunneling at least a portion of the data between the access device and the aggregation server using a layer 2 tunnel when the single path network does not provide a direct layer-2 connectivity.

Other features of various embodiments will be apparent from the accompanying drawings and from the detailed description that follows.

### BRIEF DESCRIPTION OF THE DRAWINGS

Various embodiments are illustrated by way of example and not limitation in the figures of the accompanying drawings, in which like references indicate similar elements and in which:

FIG. 1 is a block diagram illustrating the details of a communication environment having a single access device connected to an aggregation server through two heterogeneous access networks, according to one embodiment.

FIG. 2 is a block illustrating the details of a communication environment having a single access device connected to an aggregation server through multiple heterogeneous access networks, some of which does not provide a direct layer-2 connectivity and hence includes a proxy device, according to another embodiment.

FIG. 3 is a block illustrating the details of a communication environment having a single access device having a co-located proxy device connected to an aggregation server through multiple heterogeneous access networks, some of which do not provide a direct layer 2 connectivity, and may generate separate IP address for the access device, according to a further embodiment.

FIG. 4 is a block diagram illustrating the details of a secure and selectively encrypted communication environment having a single access device connected to an aggregation server through multiple heterogeneous access networks that do not provide a direct layer-2 connectivity, but generate separate IP address for the access device, according to yet a further embodiment.

FIG. 5 is a block diagram illustrating a computing system that may represent a structure of the access device, proxy and/or the aggregation server, according to yet another embodiment.

FIG. 6 is a process flow illustrating a method of an access device, according to various embodiments.

FIG. 7 is a process flow illustrating a method of an aggregation server, according to various embodiments.

### DETAILED DESCRIPTION

Methods and apparatuses of multi-link point to point protocol over heterogeneous single path access networks are described. In the following description, numerous specific details are set forth. However, it is understood that embodiments may be practiced without these specific details. In other instances, well-known components, structures, and techniques have not been shown in detail in order not to obscure the understanding of this description.

Reference in the specification to “one embodiment” and/or “an embodiment” means that a particular feature, structure, and/or characteristic described in connection with the embodiment is included in at least one embodiment. The appearances of the phrase “according to one embodiment”, “may”, and “can” in various places in the specification do not necessarily all refer to the same embodiment.

Seamless mobility and continuous connectivity, especially when access devices utilize communication facilities offered by multiple access networks is important. In the case of static devices, the connectivity needs to be continued seamlessly, even if connectivity provided by one of the access networks fails. Similarly in the case of wireless devices, it is important that any data/voice sessions continue seamlessly, even if the availability of access networks changes, because of the device mobility.

An access device provided according to an embodiment, sets up several layer-2 PPP sessions, in the available access networks. These layer-2 sessions terminate at an aggregation server. Now higher layer packets such as IP packets can be sent on such layer-2 connection. Such an approach provides seamless continued connectivity across many available access networks. Thus the bandwidth available on multiple access networks can be used simultaneously as well, thereby providing enhanced throughput performance and seamless mobility and connectivity for the applications on access devices. Also the current embodiments may propose to employ a proxy device (either separately and/or in a co-located mode) to (securely) transport such layer-2 sessions between access-device and aggregation-server over IP networks.

There are several access devices, which are designed to use multiple heterogeneous access networks. For example, a mobile device (or a smart-phone and/or a lap-top computer) may be designed to operate with several of the wire-less and wire-based access networks noted above. Similarly, static devices such as customer premise equipment (CPE), intelligent modems and/or a gateway/router device may be connected to many access networks such as cable, telephone lines, wireless networks etc. to provide connectivity on those paths.

An access network generally contains many such access devices, which operate according to pre-specified protocols to provide connectivity to one or more end devices. The end devices are themselves computing devices, which provide networking and communication facilities for their users/applications. In certain cases, like laptops, Smart-phones etc., these access devices might themselves be end-devices as well.

Access networks are implemented using various wire-less and wire-based technologies and virtual links. Examples of wire-less technologies include GPRS (General packet radio service), UMTS, CDPD, CDMA, WCDMA, DVB, WLAN, and WiMAX. Examples of wire-based technologies include digital subscriber loop (DSL), Cable (various flavors), Ethernet (includes many flavors), optical interfaces, WAN links, ATM links, etc. Examples of virtual links could include transport tunnels like Traffic engineered MPLS tunnels, Security tunnels like IPSec, SSL etc.

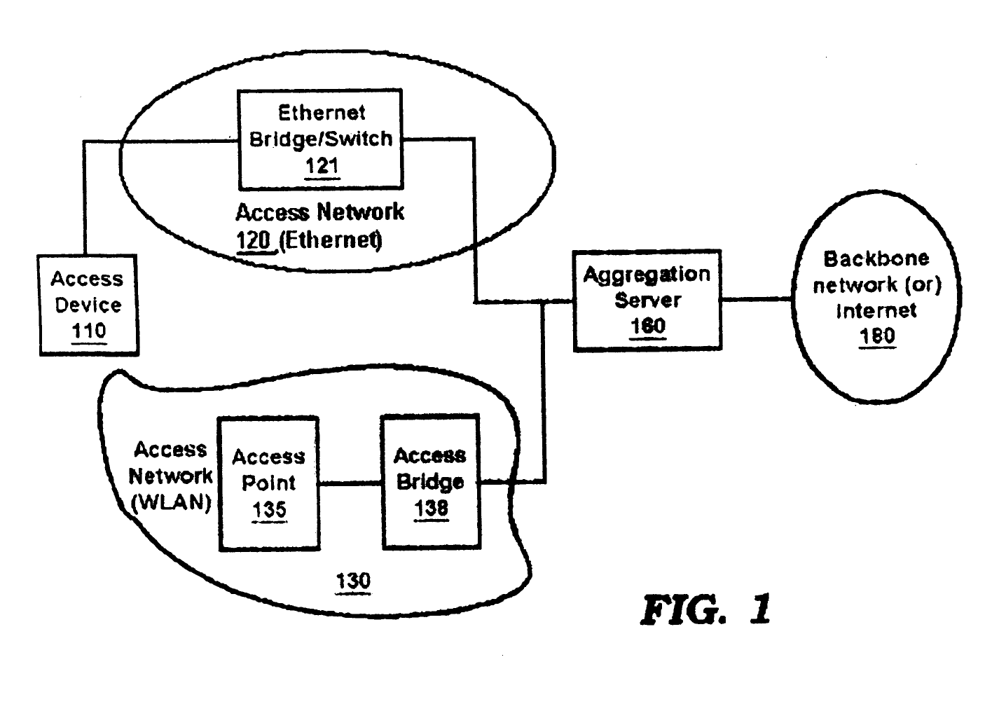

FIG. 1 is a block diagram illustrating the details of a communication environment having a single access device 110 connected to an aggregation server 160 through two heterogeneous access networks (e.g., an Ethernet access network 120 and a WLAN access network 130), according to one embodiment. The FIG. 1 is shown containing access device 110, bridge (Ethernet bridge/switch) 121 contained in access network 120, access point 135 and access bridge 138 contained in access network 130, aggregation server 160, and Internet 180. Each block is described below in further detail.

Internet 180 provides connectivity to various servers (not shown) for packets received from aggregation server 160. Access networks 120 and 130 represent example access networks, which provide connectivity to access device 110, as described below.

Access network 120 provides connectivity using Ethernet technology (example of wire-based), and bridge 121 supports Ethernet protocol. Similarly, access network 130 provides wireless connectivity using WLAN technology, and access point 135 supports WLAN technology. Access bridge 138 and access point 135 may be connected using Ethernet type high-bandwidth connection and access bridge 138 may be connected to the aggregation server 160 once again via Ethernet type high-bandwidth connection.

Access device 110 sets up a first layer-2 (PPP) connection using access network 120 and a second layer-2 (PPP) connection using access network 130. The two layer-2 (PPP) connections terminate at aggregation server 160 and are aggregated to form a MLPPP bundle. This bundle is used to transport various IP (layer-3) packets. Each of the sessions may be setup according to PPPoE/PPP/MLPPP protocol described in related IETF RFCs. An approach requires that such bundles be created for efficient and simultaneous use of heterogeneous access networks.

Multi-Linking PPP Sessions

The manner in which the PPP sessions are established and used is described in the context of the present embodiment. It is assumed that Interface1 connecting to access network 120 is Ethernet based, and Interface2 connecting to access network 130 is WLAN. Though the embodiment is described with two interfaces for conciseness, an access device can have multiple interfaces connecting many access networks.

Access device 110 begins by connecting itself to Interface1 and then initiates the PPPoE session. It establishes the PPP link first and places the PPP link in a MLPPP bundle by using MLPPP protocol (e.g., may be as described in RFC 1990 entitled “The PPP Multilink protocol (MP)”). Then the access device 110 begins the NCP protocols, negotiates an IP-address for the bundle, and begins network layer transactions.

Next, the Access device 110 detects the presence of Interface2. It establishes another PPP link using WLAN interface using PPPoE protocol, and adds this PPP link to the same MLPPP bundle (previously established) (e.g., may be as described in Sec. 5 of RFC 1990). Since the IP-layer connectivity is already available for the bundle, no NCP negotiations happen.

Whenever a new interface is activated, whether to create a new MLPPP bundle (or) to re-use an existing MLPPP bundle is determined, based on a policy-setting/application environment and is to be in adherence with the criteria of Sec.5 in RFC1990. In this example, it is assumed that the PPP session over the interface2 (WLAN) is also included in the existing MLPPP bundle.

The network-layer traffic is sent over the MLPPP bundle and such traffic gets distributed over both the links, based on a pre-determined policy. Both access device 110 and aggregation server 160 individually applies such policy at their own ends, on how to distribute the data-stream over the active links. (e.g., RFC-1990 Section-3 may be used).

Individual PPP Link disconnection is achieved by using the regular PPP Terminate/Terminate-Ack transactions. The links might also fail, because of some lower-layer failure in the devices/networks. Link-failure/disconnection is detected by one of the following methods (a) noticing the missing PPP keep-alive packets (or) (b) by link-failure alarms/events (or) (c) by other events in the systems, whichever is earlier. The earliest detection will prevent unnecessary data-flow in the failing link. If any of the links become unavailable/disconnected, that link will be disconnected from the existing MLPPP bundle, while the remaining links in the bundle continue to carry the data-traffic (e.g., the details may be those of Sec.7 of RFC1990).

Whenever only one link is active, the solution assumes that the multi-link header is still actively used, so that anytime a new link(s) join(s) the MLPPP bundle the traffic can be distributed once again. Thus, the approach of FIG. 1 described above enables multiple access networks to be used efficiently by using multiple layer-2 sessions, to achieve various features of the present embodiment.

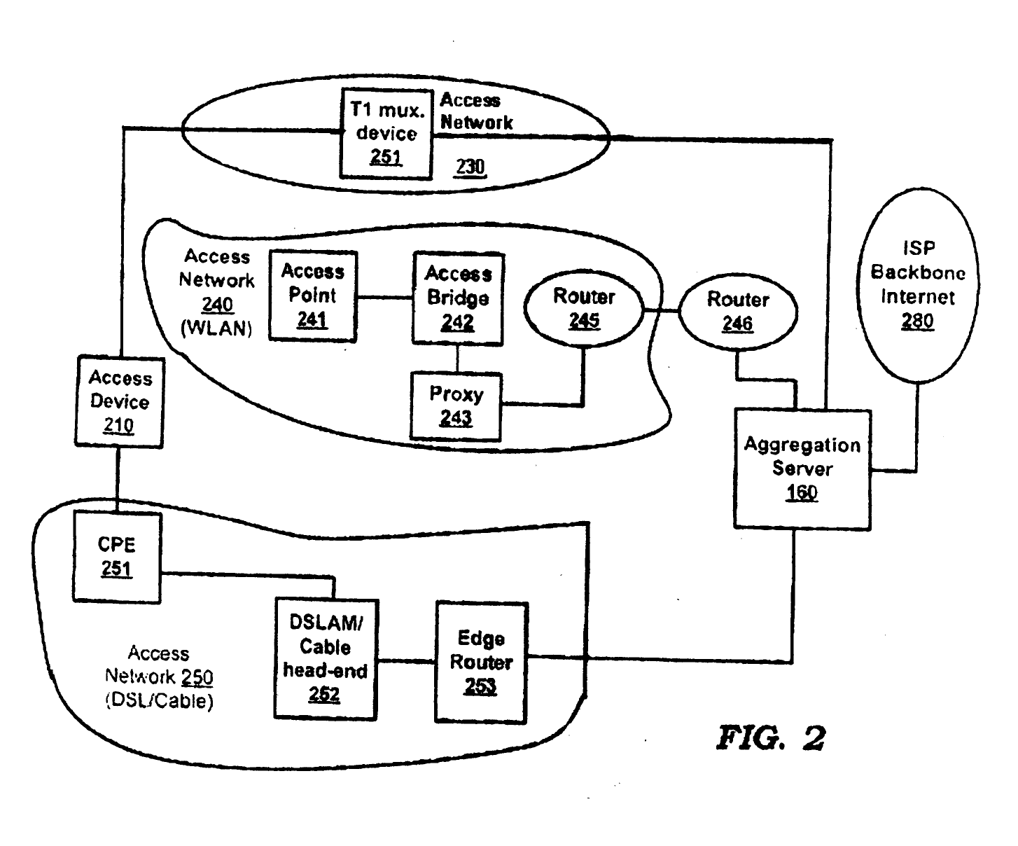

However, in some environments, a direct layer-2 connectivity may not be available. In such situations, a proxy may be employed at the boundary of the access network to provide the “extended” layer-2 connectivity as described below with respect to FIG. 2.

Use of Proxy

FIG. 2 is a block illustrating the details of a communication environment having a single access device 210 connected to an aggregation server 160 through the heterogeneous access networks a WLAN network 240 and a DSL/Cable network 250 one of which of the heterogeneous access networks includes a proxy device 243, according to another embodiment. FIG. 2 is a block diagram of another example environment illustrating the manner in which a proxy can be used when layer-2 direct connectivity cannot be established, for example, due to administrative restrictions of disparate networks in the connection path. FIG. 2 is shown containing access device 210, access networks 230, 240 and 250, aggregation server 160, and Internet 180. Each block is described below in detail.

Access network 230 is shown containing T1 multiplexer device 231, and access network 250 is shown containing CPE 251, DSLAM device 252, edge router 253. Access networks 230 and 250 are assumed to support a direct layer-2 connectivity between access client 210 and aggregation server 160, and can be implemented using several commercially available components.

Access network 240 is shown containing proxy 243, which enables to extend the layer-2 PPP session establishment, in combination with access point 241 and access router 242. Without proxy 243, such a direct connection may not be possible since routers 245, 246 forces the termination of the layer-2 connectivity. The details of an example implementation of proxy 243 is described below.

In an embodiment, portion of proxy 243 is implemented using L2TP protocol (e.g., may be as described in RFC 2661 entitled, “Layer Two Tunneling Protocol”). However, for achieving the features put forth in the present embodiment, the proxy 243 needs to transport the MLPPP control and data packets from access device 210 to aggregation server 160. The details of proxy 243 is described below.

In one embodiment, the proxy 243 can be assumed to be capable of acting as PPPoE server, if needed, to terminate access device's PPPoE sessions. Proxy 243 acts as a L2TP LAC, and the aggregation server 160 acts as LNS server for the purpose of this example. It is also assumed that the access device 210 and aggregation server 160 also are capable of carrying MLPPP control and data packets via the L2TP tunnel established between proxy 243 and aggregation server 160.

It is assumed that in the following data-communication environment, the access device 210 has 3 interfaces—Interface1 (to access network 230) is connecting to fixed line T1 network, interface2 (to access network 240) is public-WLAN and interfaces (to 250) is to DSL CPE 251 (accessed via USB/blue-tooth). Access device 210 establishes PPP session via the T1 mux device using interface1. Similarly when the WLAN access is available, access device 210 establishes a PPP session using PPPoE protocol over WLAN using interface2. When the connection to access DSL network is detected, access device 210 begins PPP link establishment procedures via edge router 253.

On interface1 and interface 3, the PPP link gets established due to the direct layer-2 connectivity and access-device 210 and aggregation server 160 proceed to MLPPP negotiations. In the case of PPP link on interface-2, Proxy 243 takes the responsibility of carrying such a PPP-session, to aggregation server 160, using L2TP protocol, (e.g., may be as described in RFC-2661). L2TP protocol allows these PPP sessions to be transported over the intermediary IP network/internet.

However, in an embodiment, on top of the regular L2TP protocol, proxy 243 also transports the MLPPP negotiations between the access device 210 and aggregation server 160 through the tunnel. Aggregation server 160 terminates the L2TP tunnels and sessions from different proxy devices. It decapsulates the L2TP tunnel/session headers and picks out individual PPP sessions and performs MLPPP negotiations.

Aggregation server 160 aggregates these multiple PPP sessions into a single MLPPP bundle. In one scenario, in which a single Proxy device terminates, all possible access-methods for a access device 210, proxy itself can terminate the MLPPP session, and originate a single L2TP tunnel/session towards the Aggregation server 160. Example would be a DSL-aggregation-router, terminating 2 (or more) DSL links for the same customer, and the customer doesn't have/want to use other access methods for the multilink.

Aggregation server 160 and access device 210 negotiate the NCP protocols (as described in RFC1990), exchange an IP-address and begin network layer data-transfer. Similarly as more and more interfaces are detected, the above procedures are repeated, and the MLPPP bundle expands across such multiple interfaces. Now, (e.g., may be as described in the MLPPP RFC), if any of the links fail, the traffic continues to go over the remaining links. This embodiment is used for providing seamless-mobility (“Continuous Connectivity”) service for the end-terminal, when the terminal is accessible across a variety of heterogeneous media.

This could also be referred as inter-technology handoffs. It may be noted that these features could also be used for providing mobility services for intra-technology-handoffs also. For example, instead of using GTP tunneling for providing mobility service in GSM, various features of the present embodiment could also be used.

Thus, proxy 243 enables establishment of layer-2 sessions to form MLPPP link-bundle over an IP network in the above example.

Although the proxy device is shown as a separate device, its functionality can be easily integrated into the devices like Edge Router, GGSN/cellular gateways etc. However, there are often scenarios in which it may not be possible (for example, if the administrator of access network does not agree) to have direct layer-2 access to aggregation servers and beyond (or) to allow deployment of such proxy devices in their access networks. In that case, it is not necessary to implement proxy as a separate device. In such scenarios, proxy can be integrated into access device also, and is described in the following sections.

Use of Co-Located Proxy Device.

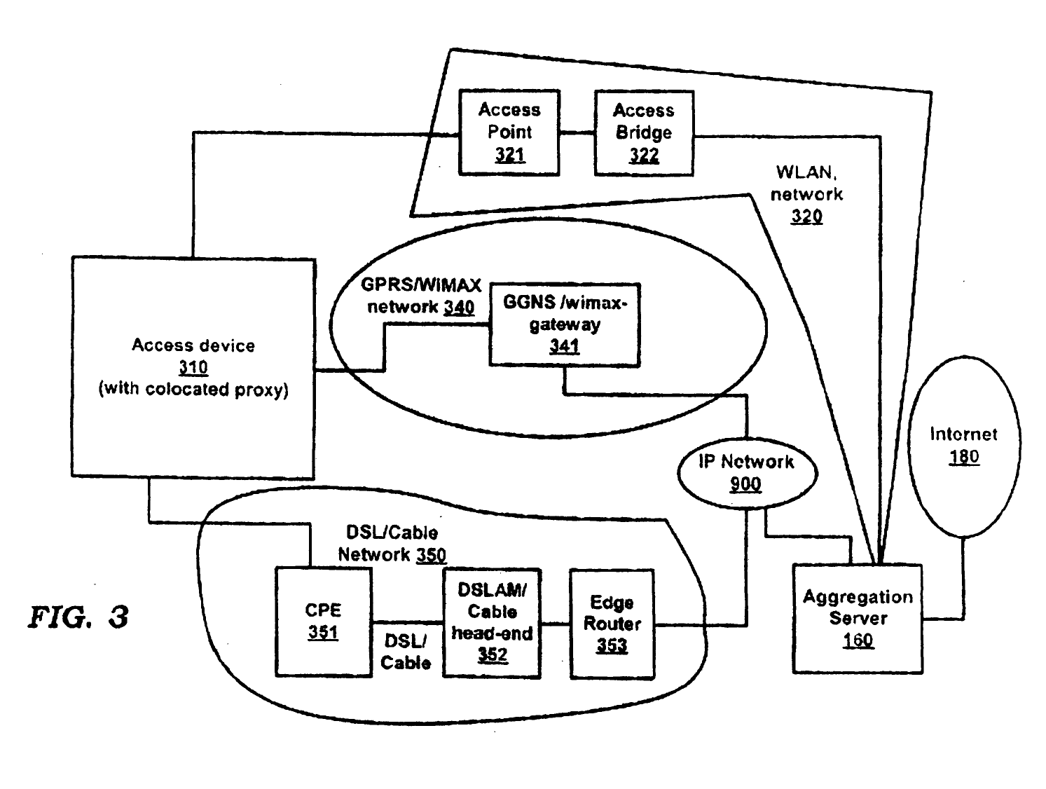

FIG. 3 is a block illustrating the details of a communication environment having a single access device 310 having a collocated proxy device connected to an aggregation server 160 through the heterogeneous access networks a GPRS/WiMAX network 340 and a DSL/cable network 350 according to a further embodiment. The example scenario, in which a proxy can be integrated into access device, is depicted in FIG. 3. The co-located Proxy is depicted as access device 310. FIG. 3 is shown containing access device 310, access networks 320, 340 and 350, aggregation server 160, and IP networks 180 and 390. IP network 900 provides the transit network for access device 310 to reach aggregation server 160 over an IP network. Each block is described below in detail.

Access network 320 is shown containing an Access point 321, Access bridge 322 which is connected (using Ethernet and/or similar type connection) to aggregation server 160. Access network 340 is shown with a GGSN/wimax gateway 341, and access network 350 is shown containing CPE 351, DSLAM/cable head-end device 352, edge router 353. Access networks 320 is assumed to support a direct layer-2 connectivity and access networks 340 and 350 are assumed to be connected to the aggregation server 160 via a transit IP network 900.

Access device 310 is a special access device with a co-located proxy functionality for the purpose of discussing the features of the present embodiment. In an embodiment, portion of access-device 310 is implemented using L2TP protocol (e.g., may be as described in RFC 2661). However, for achieving the features put forth in the present embodiments, the access device 310 needs to transport the MLPPP control and data packets from/to aggregation server 160 via direct PPP links, as well as L2TP-tunnel extended PPP links. The details of proxy 310 are described below.

Similar to the previous example described, the aggregation server 160 acts as LNS server for the purpose of this example also. It is assumed that in the following data-communication environment, the access device 310 has 3 interfaces—Interface1 (to access network 320) is connecting to WLAN network, interface2 is connecting to GPRS (/wimax) network (access network 340) and interfaces (to access network 350) is DSL/Cable (accessed via USB/bluetooth).

Access device 310 establishes PPPoE/PPP session with the WLAN access using interface1. As soon as PPP session gets established, the access device 310 is ready to proceed to perform MLPPP negotiations with aggregation server 160.

In the case of access networks 340 and 350, however as soon as link layer protocols are established, an IP-address is provided to the access-device 310 on each of those interfaces. Lets call them IPgprs and IPdsl. Assume that by using IPgprs and IPdsl, access device 310 can reach the aggregation server 160 over an IP-network 900.

Now access device begins 2 L2TP tunnels (one using IPgprs and another using IPdsl) towards aggregation-server 160. As soon as the tunnels are established, it proceeds to setup 2 separate logical PPP links, over which higher-layer PPP (including MLPPP, NCP) negotiations can happen. Of the available PPP links (one physical PPP session over Interface1, and other two logical PPP sessions over L2TP tunnels), access device 310 performs MLPPP negotiations.

The aggregation server 160 does not know whether the L2TP sessions are from a co-located proxy and/or from a regular proxy device, and continues to respond to appropriate protocol negotiations as per its configuration. Aggregation server 160 terminates the PPP sessions over L2TP tunnels from different proxy devices and regular PPP/PPPoE sessions on the direct links to the access device. It decapsulates the L2TP tunnel/session headers and picks out individual PPP sessions and performs MLPPP negotiations.

Aggregation server 160 aggregates these multiple PPP sessions into a single MLPPP bundle. Aggregation server 160 and access device 210 negotiate the NCP protocols (e.g., may be as described in RFC1990), exchange the IP-address for the bundle and begin network layer data-transfer. Similarly as more and more interfaces are detected, the above procedures are repeated, and the MLPPP bundle expands across such multiple physical and logical PPP links. Now, (e.g., may be as described in the MLPPP RFC 1990), if any of the links fail, the traffic continues to go over the remaining links. This embodiment is used for providing seamless-mobility (“Continuous Connectivity”) service for the end-terminal, when the terminal is accessible across a variety of heterogeneous media.

Thus, an access device with a co-located proxy 310 enables the various embodiments in certain networks with administrative constraints easily.

As can be seen from the above examples, the features of the present embodiments allow seamless access over multiple heterogeneous access networks. However some of the access devices are catering to the needs of corporate connectivity. Corporate users, utilizing such access devices, tend to connect to different type of applications like outlook, conferencing, ERP, CRM and many other proprietary applications, and they require secure VPN-connectivity apart from basic reliable connectivity. How such a secure connectivity is achieved is described in the following section.

Secure Mobility and Fail-Safe Access:

According to another embodiment, the access device needs to be provided with the security features while communicating with aggregation server and the networks beyond. This can be addressed using a variety of scenarios (e.g., using IPsec protocol for end-to-end security, by using RFC-3193 for securing L2TP tunnels, utilizing PPP-encryption protocols, (e.g., RFC 1968, 2419, 2420, 3078) to secure PPP sessions end-to-end, and/or similarly by using protocols like SSH/SSL to securely carry individual/end-to-end PPP links.)

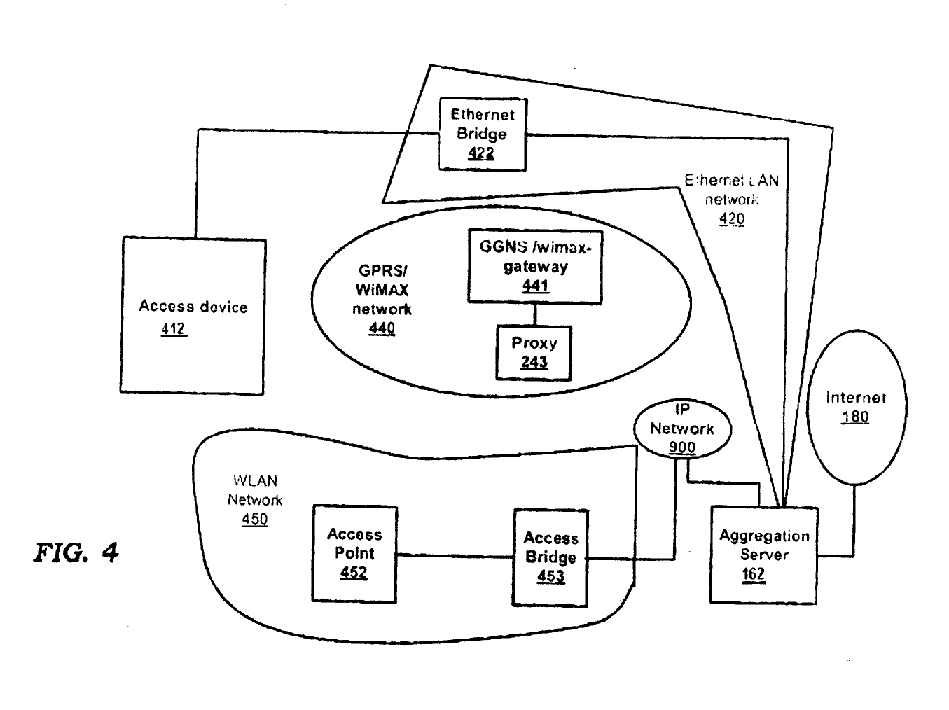

FIG. 4 is a block diagram illustrating the details of a secure and selectively encrypted communication environment having a single access device 412 connected to an aggregation server 162 through multiple heterogeneous access networks (e.g., a GPRS/WIMAX network 440 and a WLAN network 450) that generate separate IP address for the access device 412, according to yet a further embodiment. FIG. 4 depicts an example scenario illustrating additional embodiments. Note that access device 412 is configured to play the role of Securing L2TP tunnels using IPSec (as described in rfc3193). Similarly Aggregation server 162 is deployed with the same role. In this example, the access-device 412 are assumed to be access-devices with co-located proxy features. They are also assumed to have the following environment, such as 1. secure layer-2 connectivity till aggregation server 162 via access network-420; 2. secure layer-2 connectivity only till a proxy device 442 via access network-440.; and 3. insecure layer-3 connectivity to the aggregation server 162 via access network-450.

For this example, assume an access device like a laptop, could possibly get access to above 3 types of access networks. Assume access-network-420 is an Ethernet connection to the corporate, access-network-440 is a GPRS-network (whose operator hosts a proxy device 442), and access-network-450 is a WLAN-network (hosted by an ISP in the locality). Assume that the corporate network hosts an aggregation server 162 to aggregate traffic from access device over heterogeneous access networks.

Securing L2TP Using IPSec:

This could be implemented as a selectively-secure solution. That is, amongst the various access networks available between the access-device and aggregation server, only some of the access networks can be considered to be insecure, while the remaining access networks are assumed to be fully secure, with respect to the networks behind aggregation server. So the consideration here is to turn on the IPSec only for the tunnels established over such insecure access networks.

This embodiment is useful, when the IPSec for L2TP traffic need to be employed only when using insecure links, while such IPsec overhead could be turned off for the traffic flowing over the secure link. Here the L2TP tunnels in between the access-device—aggregation server, and between proxy—aggregation-server etc. are secured using IPSec (as described in RFC3193), while still utilizing the present embodiments.

FIG. 4 depicts an example environment to illustrate the present scenario. Note that access device 412 is same as access device 411 (except that 412 has been reconfigured to not perform end-to-end Ipsec, but to play the role as described in rfc3193). Similarly Aggregation server 162 is same as aggregation server 161, but for this reconfiguration.

Access-network-440 being a GPRS network can be expected to be secure at layer-2 level. However, the GPRS operator hosts a proxy-device 442 for securely transporting the traffic from access-device over an IPSec encapsulated L2TP tunnel. Such a Secure Ipsec L2TP tunnel terminates at Aggregation-server 162.

Now assume that whenever the access device 412, needs to access corporate servers over access-network-420. There's no need to enable IPSec. By following the examples above, the access device 412 establishes a MLPPP/PPP over a PPPoE link on access-network-420.

Assume that next the access device 412, detects the presence of the access-network-440. It immediately establishes a layer-2 PPP link, with the proxy 442, which establishes a Secure L2TP tunnel to the aggregation-server 162. Now access device 412 can perform MLPPP negotiation over this link also and get this link included in the previously established bundle.

Similarly once the presence of access-network-450 is detected, the access-device 412 establishes a layer-3 connectivity to the aggregation server 162 directly. This is done by using a Secure L2TP tunnel (e.g., may be as described in RFC 3193). Then a new PPP session is established over such a secure-tunnel, which gets terminated in the aggregation server 162. Then MLPPP negotiations begin and this PPP link is also included as part of the bundle.

Now regular IP traffic towards the corporate servers can be sent over the MLPPP bundle. The bundle's traffic gets split into 3 access networks. Only on V this access-network-450 which uses Secure L2TP tunnel, the traffic from the access device 412 is encrypted at network-layer. On access-network-440, GPRS layer encryption is done by access device 412, while the proxy takes care of network-layer encryption towards the aggregation server. On the access-network-420, there's no need for any network-layer encryption at all.

As may be noted that the ensuing traffic flow is secure enough for corporate applications, and also more efficient for the access-device 412, as it avoids encrypting every packet as in situation 6a) above. Furthermore, the access device 412 is relieved of extra burden of encrypting/decrypting the traffic over the wireless access network 440.

Meanwhile, the various links between the access device 412 and aggregation server 162 can go down, because of various network events/user-actions. In such instances, the appropriate PPP links (going over such access networks) are removed from the MLPPP bundle, while the other links in the MLPPP bundle continue to carry the user traffic.

Thus it can be seen that the secure access over heterogeneous access networks is facilitated using various features of the present embodiments.

Device Characteristics and Implementation:

The present embodiment may be implemented in at least 3 logical devices namely aggregation server, access device, proxy device. The aggregation server is implemented as a network device and essentially has the following functionality. This acts as MLPPP Link-aggregator and provides a single-point IP connectivity for the user. Essentially this means handling MLPPP negotiations and managing creation/teardown of links/bundles, efficient distribution of traffic across available links etc. L2TP LNS device to terminate the L2TP tunnels from Proxy devices. Aggregation server also participates as PPPoE server, in case there is a direct L2 LAN type connectivity is used and as PPP peer, in case of direct layer-2 connectivity to the access device. The server provides IPSec security to L2TP tunnels (using RFC3193), handles IPSec security for end-to-end traffic, handles additional firewall specific features like NAT-traversal etc. It should also be able to participate as a IP end-host/router and participate in Address-management, authentication for access-devices, by implementing AAA protocols, like Radius client software etc.

The access device is implemented as a client side device. This device essentially has the following functionality. It acts as MLPPP Link-aggregator and provide a single-point IP connectivity for the user applications. Essentially this means handling MLPPP negotiations and managing creation/teardown of links/bundles, efficient distribution of traffic across available links etc. It acts as L2TP LAC device to originate the L2TP tunnels when acting as co-located proxy. It participates as PPPoE client, in case there's a direct L2 LAN type connectivity is used and co-exists with Mobile-IPv4/Mobile-IPv6 protocols and methods and as PPP peer, in case of direct layer-2 connectivity is available. The part provides IPSec security to L2TP tunnels (using RFC3193) and handles IPSec security for end-to-end traffic and additional firewall specific features like NAT-traversal etc. This also participates as IP end-host/router.

The proxy device is implemented as a network element device. This acts as transparent pass through for MLPPP negotiations. It also acts a L2TP LAC device to originate the L2TP tunnels. This would also participate as PPPoE server, in case of a direct L2 LAN type connectivity with the access-device. It could also utilize RFC3193, to securely transport L2TP tunnels by IPSec. It also handles additional firewall specific features like NAT-traversal etc, and also participates as a IP end-host/router.

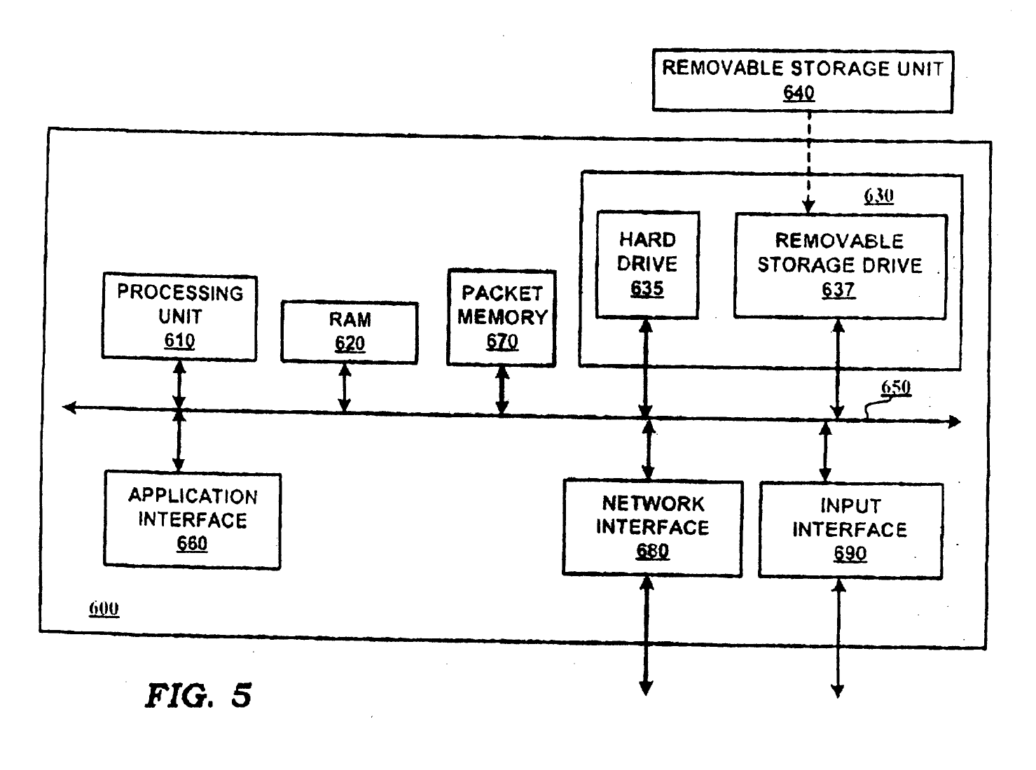

All the 3 devices could begin with a sample implementation describe in FIG. 5. This figure depicts a basic set of logical building blocks highlighting the control plane, data-plane, and management plane for the various modules involved. It may be noted that not all the embodiments is covered in the picture.

Thus it may be noted that the features of the present embodiments address the following situations and cases: •Perform MLPPP negotiations over PPP protocol carried in PPPoE sessions (over Ethernet type LAN interfaces). •Perform MLPPP negotiations over PPP protocol carried in L2TP tunnels/sessions (over IP transport). •Use other direct PPP links, where normally MLPPP option negotiations are performed (e.g., this may be as described in RFC 1990). •Aggregate such multiple PPP links on any/all of the above methods, using MLPPP protocol bundle and provide single point IP connectivity for the higher layer applications. •Use such aggregation, described above, to provide higher-aggregated speed data-access over heterogeneous media. •Use such aggregation to provide a fail-safe data-access, even if one of the available access links were to fail. •Use such aggregation to provide for seamless-roaming solution for mobile-users. Even if one of the access fails, the other links are utilized to carry data-traffic, and when the access becomes available, the link is utilized back again for data-transfer. •Utilize either (a) basic IPsec protocol for end-to-end security (b) (e.g., by using RFC 3193 (Securing L2TP using IPSec)), (c) existing PPP encryption protocols (or) d) by using PPP over other secure tunnels like SSL/SSH etc., to provide secure seamless connectivity for access devices.

•Provide easy integration of different network layer protocols and other application layer protocols, without requiring specific software upgrades/tweaks for making them mobility-aware. Reuse already existing well understood protocols like PPP, L2TP etc, for providing new services. Also reuse their facilities like authentication, IP-address management, compression schemes etc. to simplify the administration of such networks.

It should be understood that the different components of the devices/systems above could be implemented in a combination of one or more of hardware, software and firmware. In general, when throughput performance is of primary consideration, the implementation is performed more in hardware (e.g., in the form of an application specific integrated circuit).

The implementation may be performed in software (e.g., using a processor executing instructions provided in software/firmware) depending upon certain constraints (e.g., cost). Cost and performance can be balanced by implementing the systems/devices with a desired mix of hardware, software and/or firmware. An embodiment implemented substantially in software is described below.

One Implementation:

FIG. 5 is a block diagram illustrating a computing system (e.g., device 600) that may represent a structure of the access device 110 and/or the aggregation server 160 (e.g., any variations of these devices as shown in FIGS. 1-4), according to yet a further embodiment. FIG. 5 is a block diagram illustrating the details of device 600 in one embodiment. Device 600 may correspond to any of the systems/devices noted above. Device 600 is shown containing processing unit 610, random access memory (RAM) 620, secondary memory 630, application interface 660, packet memory 670, network interface 680 and input/output interface 690. Each component is described in further detail below.

The input/output interface 690 (e.g., interface with a key-board and/or mouse, not shown) enables a user/administrator to provide any necessary inputs to device 600 application interface 660 provides output signals (e.g., display signals to a display unit, not shown), and the two interfaces together can form the basis for a suitable user interface for an administrator to interact with device 600.

The network interfaces 680 and 690 provide the device 600 the capability to send/receive data-packets to/from other systems on corresponding paths using protocols like IP, PPP, PPPoE etc. The application interface 660 provides the application api interface (example: socket-layer/pseudo-terminal interface) for the applications residing in device-600.

The RAM 620, secondary memory 630, and packet memory 670 may together be referred to as a memory. RAM 620 receives instructions and data on path 650 (which may represent several buses) from secondary memory 630, and provides the instructions to processing unit 610 for execution. Packet memory 670 stores (queues) packets waiting to be forwarded (or otherwise processed) on different ports.

Secondary memory 630 may contain units such as hard drive 635 and removable storage drive 637. Secondary memory 630 may store the software instructions and data, which enable device 600 to provide several features in accordance with the present embodiment.

Some or all of the data and instructions may be provided on removable storage unit 640 (or from a network using protocols such as Internet Protocol), and the data and instructions may be read and provided by removable storage drive 637 to processing unit 610. Floppy drive, magnetic tape drive, CDROM drive, DVD Drive, Flash memory, removable memory chip (PCMCIA Card, EPROM) are examples of such removable storage drive 637.

Processing unit 610 may contain one or more processors. Some of the processors can be general purpose processors which execute instructions provided from RAM 620. Some can be special purpose processors adapted for specific tasks (e.g., for memory/queue management). The special purpose processors may also be provided instructions from RAM 620.

In general, processing unit 610 reads sequences of instructions from various types of memory medium (including RAM 620, storage 630 and removable storage unit 640), and executes the instructions to provide various features of the present embodiments described above.

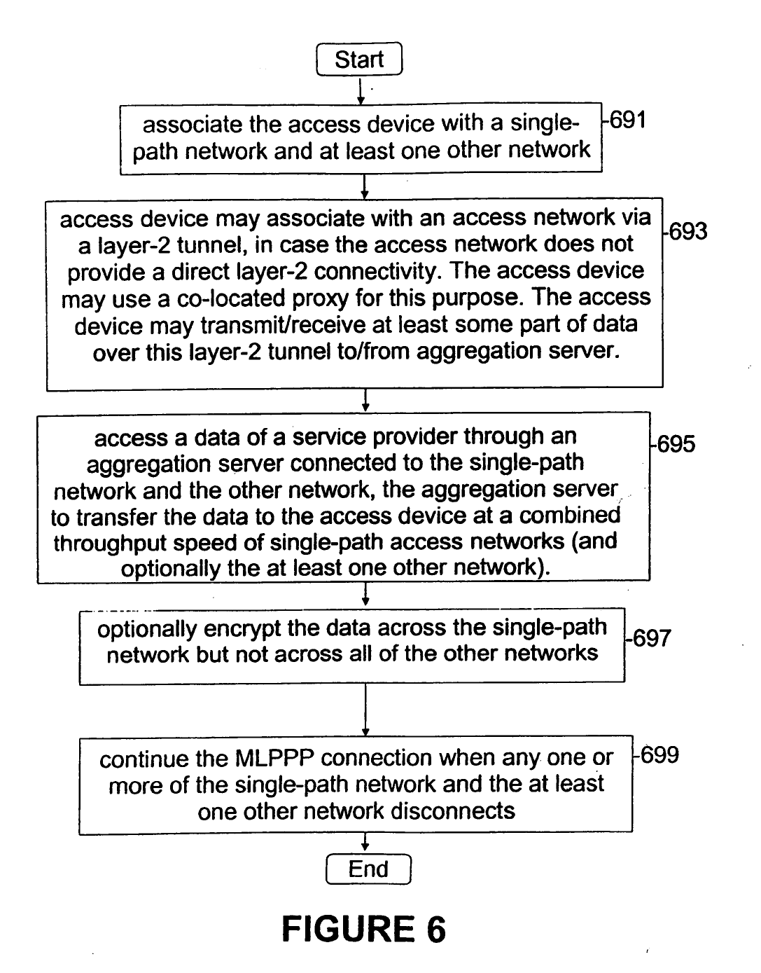

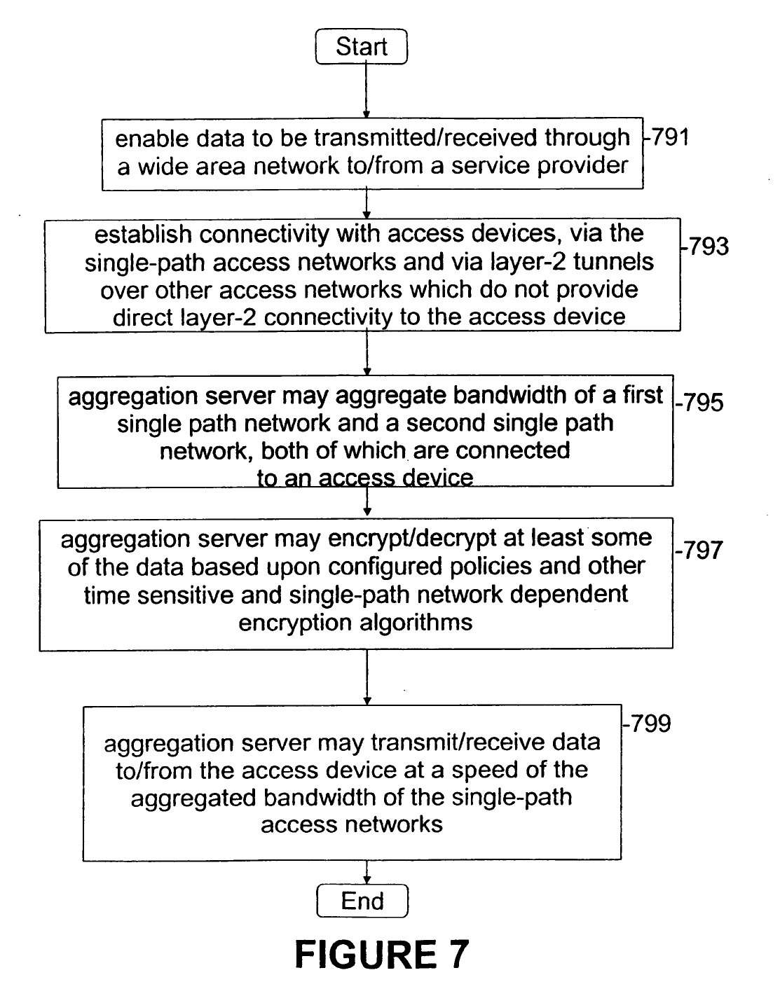

FIG. 6 is a process flow illustrating a method of an access device (e.g., the access device 110, the access device 210, the access device 310, etc.), according to various embodiments. It will be appreciated that the process flows illustrated in FIG. 6 and FIG. 7 may apply to any of the various embodiments shown in FIGS. 1-4. For example, in operation 691, the access device 110 of FIG. 1, may associate itself with a single-path network (e.g., the access network 120) and at least one other network (e.g., the access network 130). It should be noted that in operation 693 of FIG. 6, a method of access device (e.g., the access device 310) may associate itself with at least one other network (e.g., the wireless network 340 of FIG. 3), which does not provide a direct layer-2 connectivity, and may transmit at least some of the data through a layer 2 tunnel enabled through a proxy device (e.g., similar to the proxy device 243). The proxy device may also be co-located within the access device (e.g., as illustrated by the access device 310 of FIG. 3). In operation 695, the access device 110 of FIG. 1, may access the network of a service provider (e.g., a service provider offering services through the through the backbone network 180) through an aggregation server (e., the aggregation server 160) connected to the single-path network (e.g., the Ethernet network 120) and the other network (e.g., the wireless LAN network 130), the aggregation server (e.g., the aggregation server 160) to transfer the data from/to the access device 110 at a combined throughput speed of the single-path network (e.g., the Ethernet network 120) and the at least one other network (e.g., the wireless network 130).

In operation 697, the access device 110 of FIG. 1 may optionally encrypt the data (e.g., as described in detail in FIG. 4) across the single-path network (e.g., the GPRS/WiMAX network 440) but not across any of the at least one other network (e.g., the Ethernet network 420). In operation 699, the access device 110 of FIG. 1 may continue the MLPPP connection when any one or more of the single-path networks fails/restarts (e.g., to prevent a user from having to re-login and re-authenticate as described in FIGS. 1-4).

The single-path network (e.g., as described in the various operations of FIG. 6-7) may be one of an Ethernet network, a digital subscriber line network (e.g. a DSL/Cable network), and wireless access (GPRS/CDMA/WiMAX) network. The aggregation server (e.g., the aggregation server 160) may be a single point of connectivity between the single-path network (e.g., the Ethernet network 120) and the at least one other network (e.g., the wireless LAN 130) and a back-bone network (e.g., the backbone network 180). The service provider may be accessed through the back-bone network (e.g., the backbone network 180).

The associating the access device (e.g., the access device 110) with a single-path network (e.g., the Ethernet network 120) and the at least one other network (e.g., the wireless LAN 130) may be formed through point to point (PPP) negotiations between the access device (e.g., the access device 110) and the aggregation server (e.g., aggregation server 160, 162 etc.), as described in detail in FIGS. 1-4. The aggregation server 160 and the access device may form a multi-link point-to-point (MLPPP) connection over the PPP sessions created over the single-path network (e.g., the Ethernet network 120) and the at least one other network (e.g., the wireless LAN 130) to form the combined throughput speed (e.g., as described in FIGS. 1-4).

FIG. 7 is a process flow illustrating a method of an aggregation server, according to various embodiments. In operation 791, the aggregation server (e.g., the aggregation server 160 of FIG. 1, the aggregation server 162 of FIG. 4, etc.) may enable receive/transmit of data through a back-bone network from/to the service provider. In operation 793 the aggregation server (e.g., the aggregation server 160 of FIG. 1, the aggregation server 162 of FIG. 4, etc.) may optionally tunnel at least a portion of the data between the access device and the aggregation server using a layer 2 tunnel, when any one of the single path networks do not provide a direct layer-2 connectivity. In operation 795, the aggregation server (e.g., the aggregation server 160 of FIG. 1, the aggregation server 162 of FIG. 4, etc.) may aggregate bandwidth of a first single path network and a second single path network, both of which are connected to an access device.

In operation 797 the aggregation server (e.g., the aggregation server 160 of FIG. 1, the aggregation server 162 of FIG. 4, etc.) may encrypt/decrypt at least some of the data based upon time sensitive and single-path network dependent encryption algorithms of the aggregation server. In operation 799 the aggregation server (e.g., the aggregation server 160 of FIG. 1, the aggregation server 162 of FIG. 4, etc.) may transmit/receive data to/from the access device at a speed of the aggregated bandwidth.

It should be noted that the processes illustrated in FIG. 1-7 may be implemented in a system that includes a back-bone network (e.g., the backbone network 180), an aggregation server (e.g., the aggregation server 160) connected to the back-bone network (e.g., the backbone network 180) to enable a secure multi-link point to point connection over a connected heterogeneous single path access network (e.g., as described in FIGS. 1-4), a first single path network having a first access method (e.g., Ethernet) and a second single path network having another access method (e.g., DSL) connected to the aggregation server (e.g., the aggregation server 160) to form the connected heterogeneous single path access network (e.g., as described in FIGS. 1-4), and an access device (e.g., the access device 310) associated with the first single path network (e.g., the WLAN network 320) and the second single path network (e.g., the DSL/cable network 350).

In one embodiment, a connection between the access device and the aggregation server may be maintained even when any one of the first single path network (e.g., the wireless LAN 320) and the second signal path network (e.g., the DSL/cable network 350) is no longer associated with the access device (e.g., the access device 310). The system may also include a proxy device (e.g., the proxy device 243 as illustrated in FIG. 4, or the co-located proxy within the access device 310) of the first single path network (e.g., the GPRS/WiMAX network 340) to transmit/receive at least some of the data through a layer 2 tunnel when the signal path network (e.g., the wireless network 340) does not provide a direct layer-2 connectivity.

At least one of the access device (e.g., any of the access devices illustrated in FIGS. 1-4), the aggregation server (e.g., any of the aggregation servers illustrated in FIGS. 1-4), and the proxy device (e.g., the proxy device 243) may encrypt a data transmitted (e.g., as described in FIG. 4) either of the first single path network (e.g., the Ethernet network 420) and the second signal path network (e.g., wireless LAN 450) based upon time dependant rules to form the selectively secure multi-link point to point connection. The secure multi-link point to point connection may aggregate throughput of the first single path network and the second single path network (e.g., as described in FIGS. 1-4).

Various embodiments also relate to an apparatus for performing the operations described herein. The apparatus may be specially constructed for the required purposes, and/or it may comprise a general purpose computer selectively activated and/or reconfigured by a computer program stored on the computer on a machine-accessible medium. The machine-accessible medium may include any mechanism for storing and/or transmitting information in a form readable by a machine (e.g., a computer) including a machine-readable medium. The machine-readable medium includes read only memory (“ROM”); random access memory (“RAM”); magnetic disk storage media; optical storage media; flash memory devices; electrical, optical, acoustical and/or other form of propagated signals (e.g., carrier waves, infrared signals, digital signals, etc.); etc.

The processes and operations presented herein are not inherently related to any particular computer and/or other apparatus. Various general-purpose systems may be used with programs in accordance with the teachings herein, and/or it may prove convenient to construct a more specialized apparatus to perform the operations described. The required structure for a variety of these systems will appear from the description above. In addition, various embodiments are not described with reference to any particular programming language. It will be appreciated that a variety of programming languages may be used to implement the teachings as described herein.

It should be noted that the various embodiments having modules, circuits, switches, devices, tables, processors, and electronics described herein may be performed within hardware circuitry (e.g., logic circuitry such as CMOS based circuitry) as well as in software (e.g., through machine-implemented methods and/or through machine-readable mediums). Specifically, it should be noted that an architecture for the aggregation server 160, the access device 110, the proxy 243, the access device 310 with a collocated proxy 310, the access device 412, the aggregation server 162, etc. of FIGS. 1-7 can be implemented in some embodiments with software (e.g., programming code generated in machine language, C, C++, and/or any other type of programming language and accessible through a machine readable medium).

Furthermore, it should be noted that the architecture may be implemented with one or more semiconductor devices including circuitry such as logic circuitry to perform its various functions as described above. In some embodiments, hardware circuitry may provide speed and performance advantages over software implementations of the aggregation server 160, the access device 110, the proxy 243, the access device 310 with a collocated proxy 310, the access device 412, the aggregation server 162, etc. of FIGS. 1-7. In other embodiments, software implementations may be preferred. In one embodiment, the aggregation servers shown in FIGS. 1-5 (e.g., the aggregation server 160, 162) and/or the proxy device 243 and/or the access device with co-located proxy 310 may be designed using the general-purpose network-processors, ASIC, FPGA and other programmable logic devices and circuits, or a combination of them (e.g., logic circuitry such as CMOS based circuitry). A semiconductor chip may implement the functions (e.g., as described in FIG. 1 thru FIG. 7) described within the various embodiments using logic gates, transistors, and hardware logic circuitry associated with implementing the various embodiments disclosed herein.

In the foregoing specification, the embodiments have been described with reference to specific exemplary embodiments thereof. It will be evident that various modifications may be made thereto without departing from the broader spirit and scope of the embodiments as set forth in the following claims. For example, in some embodiments, the concepts disclosed herein may be applied to other networking standards and protocols consistent with this disclosure which are similar to, but not explicitly confined to the multi-link point to point (MLPPP), the Ethernet networks, the internet protocols (IP), and/or the various other networks, gateways, proxies explicitly disclosed herein. The specification and drawings are, accordingly, to be regarded in an illustrative sense rather than a restrictive sense.

What is claimed is:

1. A method of an access device, comprising;
associating the access device with a single-path network and at least one other network; and
accessing a data of a service provider through an aggregation server connected to the single-path network and the other network, and enabling to transfer the data between the aggregation-server and the access device at a combined throughput speed of the single-path network and the at least one other network.

2. The method of claim 1, further comprising maintaining a connection between the access device and the aggregation server even when any one or more of the single-path network and the at least one other network disconnect.

3. The method of claim 2, wherein the at least one other network to communicate at least some of the data through a layer 2 tunnel enabled through a proxy device within the at least one other network.

4. The method of claim 3, wherein the proxy device is also co-located within the access device.

5. The method of claim 1, further comprising encrypting the data across the single-path network but not across any of the at least one other network.

6. The method of claim 5, wherein the encrypting the data is performed selectively only during a given time interval.

7. The method of claim 1, wherein the single-path network comprises one of an Ethernet network, a digital subscriber line network, a cable network, a leased-line/dial-up network, and wireless access network.

8. The method of claim 1, wherein the aggregation server is a single point of connectivity between the single-path network and the at least one other network and a back-bone network.

9. The method of claim 8, wherein the service provider is accessed through the back-bone network.

10. The method of claim 1, wherein the associating the access device with a single-path network and the at least one other network is formed through at least one point to point (PPP) negotiation between the access device and the aggregation-server.

11. The method of claim 10, wherein the aggregation server and the access-device form a multi-link point-to-point (MLPPP) connection of the single-path network and the at least one other network to form the combined throughput speed.

12. The method of claim 11, further comprising continuing the MLPPP connection when any one or more of the single-path network and the at least one other network is disabled.

13. A system, comprising:
a back-bone network;
an aggregation server connected to the back-bone network to enable a secure multi-link point to point connection over heterogeneous single path access networks;
a first single path network having a first access method and a second single path network having another access method connected to the aggregation server to form an aggregated connection;
an access device associated with the first single path network and the second single path network; and
a proxy device in the first single path network to transport the layer-2 session between the access-device and aggregation-server, when the first single-path access network does not provide direct layer-2 connectivity.

14. The system of claim 13, wherein a MLPPP connection between the access device and the aggregation server is maintained even when any one of the first single path network and the second signal path network is no longer associated with the access device.

15. The system of claim 14, further comprising a proxy device of the first single path network to communicate at least some of the data through a layer 2 tunnel when the single path network does not provide a direct layer-2 connectivity.

16. The system of claim 15, wherein at least one of the access device, the aggregation server, and the proxy device to encrypt a data transmitted either of the first single path network and the second signal path network based upon at least one of time dependant rules and other administrative policies to form the secure multi-link point to point connection.

17. The system of claim 13, wherein the secure multi-link point to point connection to aggregate throughput of the first single path network and the second signal path network.

18. The system of claim 17, wherein the first single path network having the first access method is an Ethernet network and the second single path network having the another access method is a wireless local area network.

19. A machine-accessible medium that provides instructions that, if executed by a processor, will cause the processor to perform operations of an aggregation server, comprising:
receiving a data through a back-bone network from a service provider;
aggregating bandwidth of a first single path network and a second single path network, both of which are connected to an access device;
encrypting and decrypting at least some of the data based upon time sensitive and single-channel network dependent encryption algorithms of the aggregation server; and
transmitting the data to the access device based upon the time sensitive and single-channel network dependent encryption algorithms through a speed of the aggregated bandwidth.

20. The machine-accessible medium of claim 19, further comprising tunneling at least a portion of the data between the access device and the aggregation server using a layer 2 tunnel, when one or more of the single path networks do not provide a direct layer-2 connectivity.
